(19) United States
(12) Patent Application Publication
(10) Pub. No.: US 2002/0067608 A1
(43) Pub. Date: Jun. 6, 2002

(54) Externally powered LED flashlight

(76) Inventors: Andrew John Kruse, Flagstaff, AZ (US); Robert Luke Morales, Flagstaff, AZ (US)

Correspondence Address: John VandenBosche, 17405 NE 131 Street, Redmond, WA, 98052, US

(21) Appl. No.: 09/729,235

(22) Filed: Dec. 5, 2000

(51) Int. Cl. F21V 33/00

(52) U.S. Cl. 362/109; 362/183; 362/234; 362/800

(57) ABSTRACT

A flashlight that utilizes an ultra-bright LED light source to achieve bright light output at low power consumption. The flashlight is powered by the batteries in a portable electronic device such as a cellular telephone, a portable radio, or a personal data appliance. The flashlight connects to the battery in the portable electronic device through a plug that is inserted into the AC adaptor receptacle of the device.

### BACKGROUND OF THE INVENTION

This invention relates to an the use of an ultra bright Light Emitting Diode (LED) in a flashlight device. Specifically, the invention relates to a flashlight that uses a common external power supply to provide electrical power to the LED. The external power supply is contemplated to be provided by a separate electronic device such as a cellular telephone, pager, personal data appliance (PDA), cassette player or radio.

Flashlights are well known and have been used for a long time to provide light for activities such as camping, hiking, reading, or working outdoors at night time. Flashlights almost always consist of four essential elements; a body assembly, a battery power supply, a switch, and a light bulb. There are many variations on the common flashlight. For instance battery can be disposable or rechargeable, the switch can provide a simple on/off function or it can provide varying levels of light, and the light bulb can be of various types and can have any desired power output. Flashlights have been designed for many different specialized applications and are found in all shapes and sizes.

In recent years, there has been a proliferation of portable hand-held electronic devices which consumers have become accustomed to carrying. Portable radios or tape players either with speakers or headphones are very common. Cellular telephones and pagers have been gaining more users and are becoming a standard mode of communication. More recently, hand-held computers and personal data appliances such as the Palm Pilot TM have been spreading in popularity. As electronics become more miniaturized and are capable of performing increasingly complex tasks it is not difficult to envision an entire range of portable electronic devices that could become ubiquitous. All of these devices include batteries that are suitable for powering a flashlight. However, hand-held electronic devices rarely include flashlight features. This is because their battery capacity is limited and it is desirable to conserve battery power for use by the device itself. Standard flashlights would draw enough power to reduce the battery life in the portable electronic device to impractical levels. However, that is largely because of the current draw that is required by standard flashlights.

In just the last few years, manufacturers such as Hewlett Packard and Nichia Electric have developed an entirely new series of ultra-bright, low power consumption LED lights such as Gallium Nitride or InGaN lights. These LED bulbs provide as much as 10,000 times as much illumination as a conventional LED. They are available in red, green, blue, and amber colors. In 1997, Nichia Electric of Japan made a breakthrough with the development of a white ultra-bright LED. These new white ultra-bright LEDs can now be found in devices such as streetlights, signaling devices, key chain lights, and small flashlights.

### SUMMARY OF THE INVENTION

According to the present invention, a flashlight is provided with an ultra-bright LED bulb and it is powered utilizing the batteries in a hand-held consumer electronic device such as a radio, a cellular phone, or a personal data appliance. Because of the extremely low power consumption of the new ultra-bright LEDs, a flashlight can be powered off of the batteries in another electronic device without appreciably shortening the life of the batteries. Power is provided to the flashlight by plugging it into the AC adapter outlet in the electronic device.

The invention includes mechanical and electrical features built into the flashlight to enable the light to be powered by batteries in a hand-held consumer electronic device. Most portable electronic devices include a receptacle in which a plug may be inserted to provide AC power for operating the device or for recharging batteries in the device. The flashlight of the present invention is powered by plugging it into the AC outlet, or by building the light directly into the battery. In the case that the light is powered by the AC outlet, a plug is utilized that is modified to disable a switch that may be included in the outlet to disconnect the batteries when a plug is inserted into the outlet.

In one embodiment of the invention, the flashlight is housed in a small molded plastic body and includes a plug adapted to fit into the AC adapter receptacle in the portable electronic device. A switch may be built into the plastic body to allow the light to be switched on and off, or the light may be unswitched and controlled merely by plugging and unplugging it. The plug for the light may be integral with the plastic body, or it could be attached to the plastic body with a lanyard and electrical extension cable. It is contemplated that the plastic body that houses the flashlight could include thermally conductive plastic fins. The fins allow a user to more easily grip the flashlight and also serve to keep the LED cool during operation. A Velcro TM strap could also be provided for the flashlight so that it can be attached to a user's head, wrist, bicycle helmet, shirtsleeve, or eyeglasses.

In another embodiment of the invention, the flashlight is built an integral part of the battery of the portable electronic device. In this embodiment, the battery must be located on an external portion of the portable electronic device such as a cellular phone. In this embodiment, there is a switch built into the casing of the battery so that it the light may be switched on and off by pressing the switch on the battery.

The ultra-bright LED can be provided in various colors for certain applications. For instance, the light can be colored red for use by hunters. An amber light could be useful as a fog light or a white light can be used for reading.

It is contemplated that a separate battery pack could be provided for the flashlight to power it when the flashlight is not plugged into a portable electronic device. The battery pack could be available as an optional accessory for the flashlight.

It is also contemplated that the LED is removable so that it can be changed if it becomes damaged.

The foregoing objects and advantages of the invention will be more fully understood from the following detailed description of the invention and from the accompanying drawings.

### BRIEF DESCRIPTION OF THE DRAWINGS

FIG. 1 is a prior art portable electronic device, specifically a cellular telephone.

FIG. 2 is a first embodiment of the flashlight of the present invention.

FIG. 3 is a second embodiment of the flashlight of the present invention.

FIG. 4 is a portable electronic device, specifically a cellular telephone, with the flashlight of the present invention built into the battery.

FIG. 5 is a detailed view of one embodiment of the plug used to connect the flashlight of the present invention to a portable electronic device.

### DETAILED DESCRIPTION OF THE INVENTION

FIG. 1 shows a typical prior art portable electronic device 1 with which the flashlight of the present invention is to be used. Specifically, the portable electronic device 1 is illustrated as a cellular telephone. However, the flashlight could just as easily be used with any electronic device that uses a battery and that includes an AC adapter. The cellular telephone has an AC adapter receptacle 2 that is normally used for recharging the battery in the telephone, or it could be used to power the device with an AC power source. Whether the AC adapter receptacle is used for recharging batteries or for operating the device, it is designed for a small DC voltage (usually 3 VDC) to be applied to the adapter receptacle. Alternatively, instead of plugging the flashlight into the portable electronic device's AC adapter receptacle, the manufacturer of the electronic device could incorporate a special recptacle specifically for the flashlight that would allow the flashlight to be electrically connected to the device's battery.

FIG. 2 shows a flashlight according to a first embodiment of the present invention. The flashlight includes a molded plastic body 3 with an ultra-bright LED light bulb 4. An electrical extension cable 5 extends from the body 3 and includes a pair of electrical conductors therein which are connected to the ultra-bright LED light bulb 4. At the opposite end of the electrical cable 5 is a plug 6. The plug 6 is configured to be inserted into the receptacle 2 of the portable electronic device 1 in such a manner as to make electrical connection with a pair of contacts that are inside of the receptacle 2. The plug 6 is shaped to have pair of tabs 7 which facilitate plugging and unplugging from the receptacle 2. The plug 6 is also textured with ribs, indentations, or other shape that makes the plug 6 easier to grip. The ribbed fins are also used to dissipate heat generated by the LED so not to allow the device to overheat and potentially fail. A switch 8 can be located on the flashlight for switching the ultra-bright LED light bulb 4 on and off. The switch 8 is shown in FIG. 2 as being located on the plastic body 3, although it could also be located on the plug 6 or anywhere along the length of the electrical cable 5. The switch 8 could also be left out entirely without departing from the spirit of the invention. If the switch 8 is not included in the flashlight, then the light is controlled merely by plugging and unplugging it from the receptacle 2.

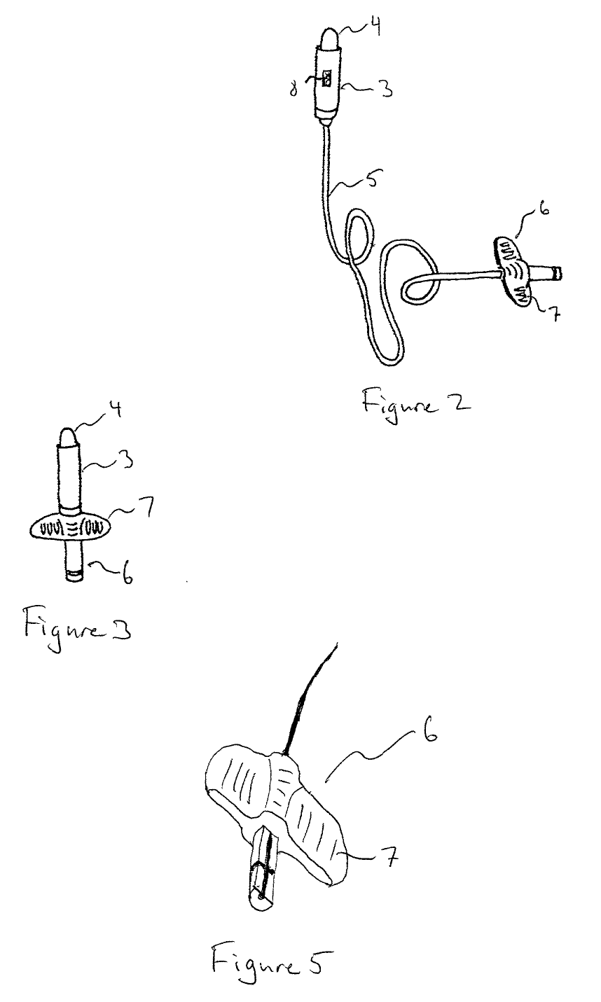

Many portable electronic devices include a switch that is incorporated within the receptacle 2 which opens the electrical circuit to the batteries when a plug is inserted into the receptacle 2. The function of the switch is to prevent accidental overcharging of a non-rechargeable battery that night be inserted in the device. The switch, however, by removing the battery from the electrical circuit would prevent it from powering the flashlight of the present invention when plugged into receptacle 2. In order to overcome this situation, the plug 6 may be formed in a semi-circular shape as shown in Figure. Because the switch is located only on one side of the receptacle 2, it is possible to insert a semi-circular plug 6 and orient it so that the switch is not activated. In this embodiment, shown in FIG. 5, the flashlight of the present invention would not include a switch for turning the light on and off, but rather would be controlled by the orientation of the plug 6 in the receptacle 2.

The ultra-bright LED light bulb 4 is preferably a Gallium Nitride LED of the type manufactured by Nichia Electric as Model Number NSPW500BS. The ultra-bright LED could be another similar type of an ultra-bright LED, but it should consume less than 100 mW of power and provide at least 2 lumens of light. The ultra-bright LED can be any color, although a white light is preferred for general use. Other colors may be preferred for specialized uses. It is contemplated that a plurality of ultra-bright LED lights could be provided in the flashlight to provide additional brightness. It is further contemplated that the ultra-bright LED light bulb could be removable and a plurality of light bulbs could be provided in varying colors. This allows the user to select the appropriate color for the particular activity in which they plan to participate.

The first embodiment of the invention, as shown in FIG. 1, could be provided with a Velcro TM strap to allow convenient attachment of the light on a user's head, wrist, bicycle helmet, shirtsleeve, or eyeglasses. The strap would be adapted to receive the plastic body 3 of the light to support the light. The strap would be sized and shaped appropriately for the desired attachment configuration.

FIG. 3 shows a second preferred embodiment of the present invention. In this embodiment, the plug 6 is integral with the plastic body 3. This embodiment has the advantage of being more compact than the first preferred embodiment. Without an electrical cable, there is nothing to get tangled and the light is easier for a user to carry in their pocket or their purse. It is contemplated that the portable electronic device 1 could include an internal compartment or an external attachment point for carrying the flashlight of the second preferred embodiment. The disadvantage of the second preferred embodiment is that the light can not be focused or directed in a desired direction without moving the portable electronic device 1. This could also be a benefit as the person using the phone could operate the light so that it shines down on the information they are reading while at the same time speaking on the phone. Because the first and second embodiments each have their particular advantages and disadvantages, it would be desirable to offer both configurations for sale to the consumer for varying uses.

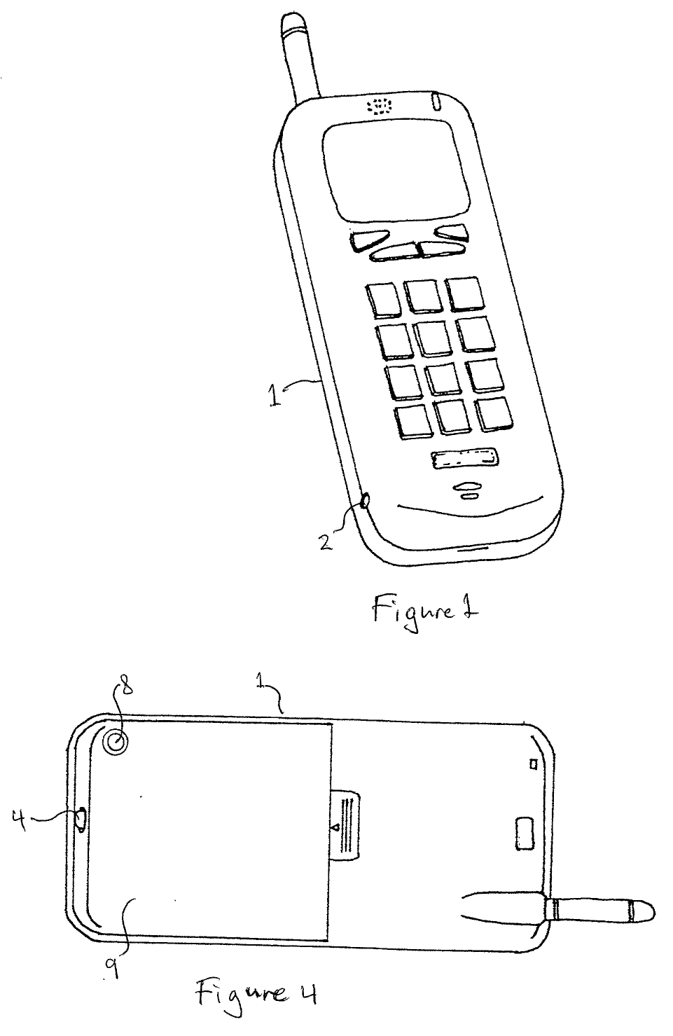

FIG. 4 shows a third preferred embodiment of the invention. In this embodiment the portable electronic device 1 has a battery 9 that is on an external portion of the device. In FIG. 4, the electronic device is shown as a cellular telephone although it is contemplated that the third preferred embodiment would work equally as well with any electronic device that has an externally located battery. In this embodiment, the ultra-bright LED light bulb 4 is integral with the battery 9 and supported thereby. A switch 8 is located on the battery for controlling the ultra-bright LED light bulb 4. Preferably the switch 8 should be designed to be easy to access and use and yet configured such that it will not accidentally turn on when the portable electronic device is being carried in a user's pocket.

While preferred embodiments of the invention have been shown and described, it will be apparent to those skilled in the art that various modifications may be made in these embodiments without departing from the scope of the invention. Therefore, it is intended that the invention not be limited to the particular embodiments disclosed but that the scope of the invention be defined by the following claims:

We claim:

1. An LED flashlight comprising:
a portable electronic device having an internal battery;
an ultra-bright LED light electrically connected to said battery; and
a switch for turning said light on and off.

2. The LED flashlight of claim 1 wherein said battery is rechargeable.

3. The LED flashlight of claim 1 wherein said battery is non-rechargeable and said portable electronic device comprises a receptacle for providing external power to said portable electronic device wherein said receptacle includes a switch for electrically disconnecting said battery when a plug is inserted into said receptacle and wherein said LED flashlight comprises a plug which can be inserted into said receptacle in a manner to bypass the switch in said receptacle.

4. The LED flashlight of claim 3 wherein plug is semi-circular in shape and wherein said switch for turning said light on and off comprises the switch in said receptacle.

5. The LED flashlight of claim 1 wherein said portable electronic device includes an external power receptacle and said flashlight has a plug that is inserted into said external power receptacle to electrically connect said flashlight to said battery.

6. The LED flashlight of claim 1 wherein said portable electronic device has an adapter receptacle made specifically for use with said LED flashlight.

7. The LED flashlight of claim 6 wherein said flashlight comprises a plastic body in which said ultra-bright LED light is mounted.

8. The LED flashlight of claim 7 wherein said plug is integral with said plastic body.

9. The LED flashlight of claim 8 wherein said plug is remote from said plastic body and an electrical cable extends between said plastic body and said plug to form an electrical connection between said ultra-bright LED light and said battery.

10. The LED flashlight of claim 1 wherein said ultra-bright LED light comprises a plurality of LED light bulbs.

11. The LED flashlight of claim 1 wherein said ultra-bright LED light consumes less than 100 mW of power and provides more than 2 lumens of light.

12. The LED flashlight of claim 11 wherein said ultra-bright LED light emits white light.

13. The LED flashlight of claim 11 wherein said ultra-bright LED light emits red light.

14. The LED flashlight of claim 1 wherein said internal battery is located on an external portion of said portable electronic device and said ultra-bright LED light is integral with said battery.

15. The LED flashlight of claim 14 wherein said portable electronic device is a cellular telephone.

16. The LED flashlight of claim 14 further comprising a switch mounted in said battery for controlling said light.
